(19) United States
(12) Patent Application Publication
(10) Pub. No.: US 2024/0349828 A1
(43) Pub. Date: Oct. 24, 2024

(54) A QUADRA LAMINA FACE MASK

(71) Applicant: COUNCIL OF SCIENTIFIC AND INDUSTRIAL RESEARCH, New Delhi (IN)

(72) Inventors: Sundergopal SRIDHAR, Hyderabad (IN); Sugali Chandra SEKHAR, Hyderabad (IN); Nivedita SAHU, Hyderabad (IN); Bukke VANI, Hyderabad (IN); Manideep PABBA, Hyderabad (IN); Fatima SAEED, Hyderabad (IN); Aarti TALLAM, Hyderabad (IN); Sai Kishore BUTTI, Hyderabad (IN)

(21) Appl. No.: 18/684,627

(22) PCT Filed: May 23, 2022
(86) PCT No.: PCT/IN2022/050483

§ 371 Date: Feb. 16, 2024

(30) Foreign Application Priority Data
Aug. 19, 2021 (IN) 202111037989

(51) Int. Cl. A41D 13/11; B01D 61/14; B01D 63/10

(52) U.S. Cl. CPC A41D 13/11; B01D 61/14; B01D 63/103; B01D 2313/14

(57) ABSTRACT

The present invention relates to the design of a face mask that incorporates a waste derived warp knit polyethylene terephthalate (PET) permeate spacer layer for daily usage in current pandemic conditions. The central layer in the face masks is a selective hydrophobic layer that is recycled from waste RO membrane modules and is intended for usage as a non-medicated multi-layered face mask for common man. The mechanical strength and shape holding capability enables the preparation of the face mask in a unique 3D shape that extends from the nose bridge to the chin, leaving an air gap between the mouth and the inner layer of the face mask. Design advantage obtained by the incorporation of the PET layer enables smooth facial movements and hindrance free speaking. The 3D folding feature of the mask is seamless and fits snug on the user's face that which prevents spectacle fogging and chances of infections.

### FIELD OF THE INVENTION

The present invention relates to the design of a face mask that incorporates a waste derived warp knit polyethylene terephthalate (PET) permeate spacer layer for daily usage in pandemic conditions. The central layer in the face masks is a selective hydrophobic layer that is recycled from waste RO membrane modules and is intended for usage as a non-medicated multi-layered face mask for common man. More particularly, the face mask is designed with four layers that include two tightly woven cotton layers as the first and fourth layers, the waste derived repurposed hydrophobic PET layer and non-woven polypropylene layer as the second and third layers, respectively. The mechanical strength and shape holding capability enables the preparation of the face mask in a unique 3D shape that extends from the nose bridge to the chin, leaving an air gap between the mouth and the inner layer of the face mask. Design advantage obtained by the incorporation of the PET layer enables smooth facial movements and hindrance free speaking. The 3D folding feature of the mask is seamless and fits snug on the user's face that which prevents spectacle fogging and chances of infections.

### BACKGROUND AND PRIOR ART OF THE INVENTION

The sudden onset of the Covid-19 pandemic has led to the development and implementation of various health-care measures and public safety guidelines, among which wearing a face mask is the primary requisite. It has been observed that countries like Italy, the United States, Canada, Brazil, Spain, etc., have been highly affected compared to Japan, Taiwan, India, etc., which are using a face mask. As the mode of transmission has been predominantly through liquid droplets carrying infective pathogens and through aerosols using a face mask has been the primary tool to fight against the virus. Studies have suggested ≥90% person to person transmission has happened through coming in contact and inhaling the infection carrying aerosols, hence, the first line of defense and controlling the spread of the virus has been the use of a face mask as suggested by most medical professionals as well as the World Health Organization's (WHO). However, as the outbreak of the pandemic was very rapid and critical, the market availability of surgical and N95 face masks was not sufficient enough to meet the demands. To meet the surge in demand and fulfill the shortage of commercial face masks an alternative low-cost face mask has been designed and developed. Covid-19 pandemic has not only dislodged the healthcare infrastructure but has also taken a severe toll on the economy and transportation making it very difficult to procure raw materials to prepare the face masks. To prevent the cumulative effect of Covid-19 on the common man an indigenous waste derived low-cost, durable, high-quality face mask that can provide protection against the virus and other pathogens has been developed. With this background, the present disclosure describes a mask configuration that is designed and developed for large-scale production that protects the common man from airborne viruses and pollutants.

Reference may be made to patent application U.S. Pat. No. 4,856,509 A, wherein implemented facemask structures with a coating of chemical on a porous film to prevent the spread of the disease such as those carried on particles of dust or in aerosol particles of body fluids described.

References may be made to patent application US 2009/0211581A1, wherein a microporous membrane layer and an absorbent textile layer were used to prepare the respiratory masks for protecting a wearer against airborne particulates, chemical vapors, and splashes.

Reference may be made to patent application U.S. Pat. No. 7,802,572 B2, wherein the invention involved the designing of facemasks with the central transparent portion, which is air-impermeable, and an outer filter portion, that consists of antimicrobial, odor-eliminating, and masking agents.

Reference may be made to patent application U.S. Pat. No. 6,412,486 B1, wherein detailed manufacturing and use of disposable filtering (membrane) masks for protecting air travelers from airborne contaminants. The mask contains two layers in which the outer layer traps the large contaminants like dust and a small portion of bacteria and other germs, and the other layer entraps the particulates that have passed through the first layer.

Reference may be made to patent application U.S. patent 20110209711 A1 1 Sep. 2011, wherein single-use protective breathing mask fabricated by spun-bounded nonwoven fabric comprising multilayers. The first intermediate layer is felt-type tribo-charged nano-fabric, and the second layer is a nonwoven ply of melt-blown microfibers.

Reference may be made to patent application US 20100101584 A1, wherein reusable mask consists of a flexible porous outer frame that can be secured to a wearer's face and a detachable semi-rigid respiratory filter that nests within the outer frame attached with one or more exhalation valves.

Reference may be made to patent application EP 0051616B1 related to the method of producing a disposable surgical mask with high bacterial filtration efficiency, conformable to the face, pliable, due to the minimum weight and minimal air resistance.

Reference may be made to patent application U.S. Pat. No. 4,790,307, wherein disposable surgical mask with self-coated antibacterial fluid at the central part of the mask which reduces the transmission of iatrogenic and nosocomial infection at operating room used by doctors and nurses.

Reference may be made to patent application U.S. Pat. No. 6,681,765 B2, wherein antiviral and anti-bacterial mask for the common man which helps to prevent the entry of bacteria, viruses, spores, algae, fungi, protozoa, and noxious or poisonous gasses through the nasal passage. This mask is lightweight, disposable, and prevents the toxic substances of organic and inorganic from the atmosphere.

Reference may be made to patent application U.S. Pat. No. 7,845,351 B2, Dec. 7, 2010, wherein face mask having germicidal properties that reduce the microbial activity. The layers used in the mask were non-woven fabric such as a spun-bond, melt-blown, or coform. The mask can be used for medical, industrial, and household applications to protect the user from dust and other harmful airborne contaminants.

Reference may be made to patent application US 2009/0320849 A1, wherein face mask consisting of filter material specially made of non-woven polypropylene and having an acidic polymer of Carbopol type deposited on the fibres. These masks have anti-viral properties to prevent inhalation of harmful viruses and other biological contaminants.

Reference may be made to patent application US2019/0215421 A1, wherein textile wastes primarily composing of cotton and wool for the production fibres. These fibres are later combined with thermoplastic binder to develop a nonwoven mat.

### OBJECTIVES OF THE INVENTION

The main objective of present invention is to design and develop multilayered reusable, washable, cost-effective, eco-friendly waste membrane derived polyethylene terephthalate (PET) permeate spacer from waste RO membrane modules incorporating face mask for the protection of the common man under varying conditions.

Another objective of the present invention is to moderate the use of raw materials and energy usage involved in the preparation of fresh PET layers that are being incorporated the design of a four-layered non-medicated face mask for general commuters, working professionals, organization employees, street vendors, sanitization zone workers, supporting staff working in hospitals, schools, crowded areas like malls, markets, etc.

Yet another objective of the present invention is to reduce plastic waste generation and sustainable reuse of the polyethylene terephthalate (PET) membrane permeate spacer in the four-layered non-medicated face mask.

Yet another objective of the present invention is to develop a simple and reproducible preparation methodology for non-medicated polyethylene terephthalate (PET) membranes permeate spacer incorporating face mask with cotton textile as the first and fourth layer and polypropylene as the third layer.

Yet another objective of the present invention is to scientifically validate the performance efficacy of the polyethylene terephthalate (PET) membrane permeate spacer incorporating face mask through permeability, durability, wash ability, liquid hold-up capacity, flame extinguishing, breathability, bacterial filtration efficiency and particulate filtration efficiency tests.

### SUMMARY OF THE PRESENT INVENTION

During this Covid-19 pandemic situation the use of a protective face mask as a preventive measure is advised for the common people also along with health care professionals by the world health organization. Since the onset of the pandemic the market demand of the face masks has exponentially increased and created an acute shortage of commercial face masks availability, The present invention provide an indigenous alternative solution for the production of multi-layered reusable face masks at an affordable price. The first aspect in the present invention is to design a non-medicated four layered face mask containing a waste/used membrane derived polyethylene terephthalate (PET) layer that is combined with two cotton layers and a polypropylene layer. Incorporation of a permeate spacer that has been obtained from a waste membrane module is a ‘waste to health’ transformation step incorporated in the mask making. Polyethylene terephthalate (PET) layer obtained from waste membrane modules offer a dual benefit in terms of resource recovery and economic viability. PET is one of the key layers in the face masks that provides structural integrity, mechanical strength, tortuosity and durability to the face mask owing to its hydrophobic and warp knit structure.

Quadra lamina facemask (four layer or laminar face mask) comprising a reused microporous hydrophobic warp knit PET [polyethylene terephthalate] permeate spacer extracted from waste spiral wound RO/UF membrane modules, which offers abatement in plastic pollution through the reuse of PET spacer component of waste spiral membrane modules. Preparation process comprises of the following layers from the outside in:
a) Outer layer [1] is comprised of tightly woven cotton textile layer with a 100×100 count specification that acts as a per-filter that prevents the entry of particulate matter of sizes ≥5-10 μm (FIG. 1 a, b) also improve the appearance of the face mask.
b) The second layer [2] consisting microporous hydrophobic polyethylene terephthalate (PET) membrane spacer fabric (FIG. 1 a) extracted from used spiral wound reverse osmosis or ultrafiltration membrane modules to repel the respiratory droplets coming in contact with the mask through electrostatic repulsion and high contact angle.
c) The third layer [3] comprises of a hydrophobic polypropylene (PP) nonwoven layer is positioned subsequent to the PET layer from the front-end side.
d) Inner layer [4] in contact with the face is made of a tightly woven cotton textile layer to provide the wearer comfort and enable prolonged usage, and said four layers (FIG. 1 a, b) are stitched tightly to offer tight porosity of ≤0.3 μm and water repulsion.

The quadra lamina multilayer PET permeate spacer face mask, wherein the woven cotton textile outer layer [1] prevents inhalation of airborne contaminants, especially large-sized particulates and gives a soft finish and proper structure to the mask providing comfort to the users.

The quadra lamina multilayer PET permeate spacer face mask, wherein microporous hydrophobic PET second layer [2] as the permeate spacer extracted from used spiral wound reverse osmosis or ultrafiltration membrane modules prepared by warp knitting for preventing inhalation of airborne contaminants such as large particulates, pollen, dust, bacteria, and other pathogens and help in reducing solid waste generation.

The quadra lamina multilayer PET permeate spacer face mask, wherein porous polypropylene non-woven third layer [3] adjacent to the PET layer which acts as a filter to restrict the pollutants or the contaminants which are not captured by other layers.

The quadra lamina multilayer PET permeate spacer face mask, wherein hydrophobic polypropylene (PP) nonwoven layer [3] is positioned next to the PET layer [2] which restricts further entry of the pollutants that pass through one and two layers.

The quadra lamina multilayer PET permeate spacer face mask, wherein the dimensions of the individual layers of the mask are measured as 9.5″×6.5″ (FIG. 3c), and 6.65″×4.55″ (FIG. 3d), are trimmed accordingly for universal size and junior size, respectively.

The quadra lamina multilayer PET permeate spacer face mask, wherein the mask is designed with an exclusive 3D pattern (FIG. 3) that has effective face coverage not restricting any facial movements, along with no difficulty in speaking and breathing and can be reused for 3 months or up to 30 washes.

Reuse and repurposing of the Polyethylene terephthalate (PET) permeate spacer obtained from waste membrane modules provides a low-cost economical viable alternative and concurrently provides a sustainable waste reuse and repurposing. It can be noted that the four layer configuration with two cotton fabrics as first and fourth layers, PET fabric and polypropylene fabric as the second and third layers incorporating face mask creates a strenuous and tortuous path that can restrict particulate matter of 0.3 μm to 10 μm sizes from causing infection. Moreover, the mask is capable of providing 95-98% rejection of respiratory droplets of a minimum 0.3 μm size. In the four layer face mask configuration, layers of the mask are non-toxic, non-allergic, non-hazardous and biocompatible. The cotton layers in the front and back offer good appearance and comfort for the wearer respectively. The second layer is the hydrophobic PET fabric that has been obtained from waste membrane modules, it is a flexible, hydrophobic, antifouling, air-permeable, waterproof and yet easy to stitch layer. The third layer consists of a microporous hydrophobic polypropylene non-woven fabric layer that barricades harmful bacteria and viruses with its tight porosity.

Other aspect of the present invention involves a simple preparation procedure that can be adopted and reproduced by a layman following a simple protocol.

Process for preparation of quadra lamina face mask, comprising: a) preparing an outer layer [1] using a tightly woven cotton textile layer with a 100×100 count specification that acts as a per-filter that prevents the entry of particulate matter of sizes ≥5-10 μμm and also improves appearance of the face mask; b) preparing a second layer [2] using a microporous hydrophobic polyethylene terephthalate (PET) membrane spacer fabric, extracted from used spiral wound reverse osmosis or ultrafiltration membrane modules, to repel respiratory droplets coming in contact with the face mask through electrostatic repulsion and high contact angle; c) preparing a third layer [3] using a hydrophobic polypropylene (PP) nonwoven layer, positioned subsequent to the PET layer from the front-end side; d) preparing an inner layer [4] having direct contact with the face using a tightly woven cotton textile layer to provide the wearer comfort and enable prolonged usage; e) stitching tightly all the layers with each-other to offer tight porosity of ≤0.3 μm and water repulsion.

Moreover, after its usage for 2-3 months the masks can be disposed of with the following methods, cotton layers can be incinerated, polypropylene layer can be recycled at solid waste management units for producing any other value-added products and the PET layer can be reused after recycling. Therefore, these non-medicated four layer face masks offer an immediate solution for the common man, frontline and sanitization workers, etc., to safe guard themselves against the infection of Covid-19 virus. The mask has been tested for bacterial filtration efficiency, particulate filtration efficiency, breathability, flammability, splash resistance, washability, liquid holdup capacity and durability at Membrane Separations Laboratory, CSIR-IICT, Hyderabad, Telangana, India. The results obtained are also certified and validated by The South India Textile Research Association (SITRA)—Centre of Excellence for Medical Textiles, Coimbatore, India. A cost comparison of the designed mask is also made with similar commercially available masks.

### BRIEF DESCRIPTION OF THE ACCOMPANYING DRAWINGS:

FIG. 1 (a) Schematic representation of a four-layered face mask incorporating the waste derived PET layer

FIG. 1 (b) Schematic representation of procuring the waste derived PET layer from the used RO/UF filtration membranes for incorporating in the face mask

FIG. 2 (a) Schematic arrangement of beads on the ear loops of the face mask

FIG. 2 (b) Pictorial representation of mask fixed with ear loop

FIG. 3 (a) Representation of frontal view of the stitched mask without and with folding along with elastic ear loop

FIG. 3 (b) Representation of rear view of the stitched mask with elastic ear loop

FIG. 3 (c) Layout of the universal fit face masks with its dimensions

FIG. 3 (d) Layout of the junior fit face masks with its dimensions

FIG. 3 (e) Photographs of the adult and junior fit face masks

FIG. 4 Representation of bacterial filtration efficiency test with open plate method

FIG. 5 Representation of particulate filtration efficiency test

FIG. 6 (a) Experimental setup of air testing cell along with circular shape mask inside the cell

FIG. 6 (b) Water permeability test experimental setup

FIG. 7 (a) SEM image of the waste derived PET layer with a magnification of 50× and scale of 1 mm

FIG. 7 (b) SEM image of the waste derived PET layer with a magnification of 150× and scale of 300 μm

FIG. 7 (c) SEM image of the non-woven polypropylene layer with a magnification of 100× and scale of 500 μm

FIG. 7 (d) SEM image of the cotton textile layers with a magnification of 50× and scale of 1 mm

### DETAILED DESCRIPTION OF THE INVENTION:

Sudden onset of the global Covid-19 pandemic has led to the development and implementation of various health-care measure and public safety guidelines, among which wearing a face mask is the primary requisite. Understanding the necessity and utility of the face masks a low-cost multi-layered face mask was designed and developed to avert the spread of COVID-19 virus. After extensive R&D regarding the material of usage in the mask and the design to offer a perfect combo of high protection at an affordable cost and good looks was performed. After which a 4 layered 3D design mask comprising of a waste derived PET was considered for development. Hydrophobic polypropylene layers were sandwiched between the textile layers, the first barrier is the waste derived PET hydrophobic layer which not only provides mechanical support to the masks but also barricades particulate pollutants from air which include dust, smoke, animal dander and pollen, etc. Polypropylene layer is non wettable and hence will not absorb the respiratory droplets and electrostatic repulsion is also possible. Microporous non-woven polypropylene layer provides extra safety with its tighter porosity. The cotton textile layer placed in the front and back of the mask ensures comfort for the wearer by moisture and temperature control along with good looks.

The prime advantage of these multilayer face masks is that they create a strenuous and tortuous path which can restrict bacteria and some of the viruses from entering the respiratory tracts as they hinder the passage of aerosols of 0.3 μm to 10 μm sizes, thereby providing effective protection. It may be noted that micro or ultra-porous membranes were found to cause difficulty in breathing and hence an antimicrobial polypropylene fabric was used instead. The masks are expected to have a shelf-life of at least 2-3 months, with periodic disinfection and gentle hand wash with mild soap under running water followed by drying. Face masks developed at CSIR-IICT are also sent for testing and certification at a standard government testing agency SITRA, Coimbatore. The present mask will be prepared as reusable personal protective equipment for the common people living in villages and towns, while a new design for health care workers and paramedical staff would be developed depending upon the test results and feedback from real-time usage.

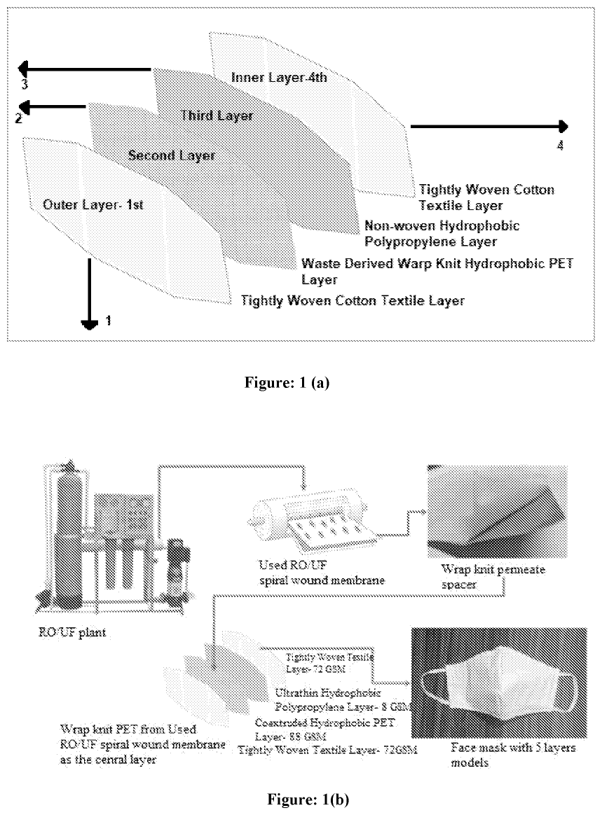

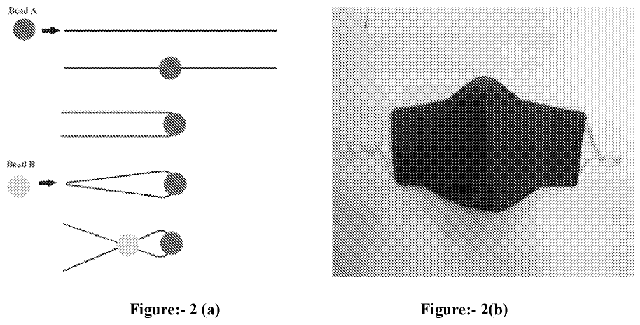

Face masks have been designed keeping in mind the prolonged usage time of ≥8 hours, which would require the mask to be comfortable without restricting any facial movements while speaking and breathing. The reuse of PET layer from waste membrane modules will help in reducing over 1 ton of plastic per every two lakh masks made. The components and arrangement of four layer of the face mask are schematically provided in FIG. 1 (a). Referring to FIG. 1 (b) is the source route in which the waste derived PET layers are obtained from the used membrane modules. After the filtration efficiency of RO/UF membranes in the water purification is reduced, inner membrane spiral is removed from the housing and cut open to extract the PET permeate spacer. The waste derived PET membrane spacer is later cleaned and disinfected to be incorporated as a central layer in the multi-layer face mask. The individual layers of the face mask are stitched at the edges to physically bind them together and soft elastic strings are attached on both sides to fasten. Adjusting beads are provided on each elastic ear loop to alter the tightness and fitting by the wearer on the face. The two different sizes of the face mask have been designed namely universal and junior for adults and children with dimensions of 9.5″×6.5″, and 6.65″×4.55″ respectively (FIG. 2). A non-return valve is deliberately eliminated from this design to avoid air contamination and disease transmission by infected persons during their exhaling. Preparation of four layered non medicated Polyethylene terephthalate membrane permeate spacer incorporating face masks configuration provided in FIG. 1. Non medicated mask consists of tightly woven cotton fabric of 75 GSM as the first and fourth layers, followed by microporous hydrophobic polyester (PET) of 90 GSM and polypropylene (PP) fabric of 25 GSM are the second and the third layers, respectively. These 4 layered masks, which can be easily breathable and used by common people, working professionals, organization employees, etc. The microporous hydrophobic polyester (PET) fabric is a first barrier that provides mechanical support to the masks and also barricades particulate pollutants from air particularly dust, smoke, animal dander, and pollen, etc. The non-wettable property of the PP layer helps to repel the respiratory droplets. Moreover, it also contains an electrostatic repulsion property. The tightly woven cotton fabric ensures comfort for the wearer by absorbing moisture while talking and thus controlling the temperature. In addition to this, the most effective four layered non medicated mask can be used to prevent the entry of airborne microorganisms. Therefore, the designed four layered masks are well suitable for general commuters, working professionals, organization employees, street vendors, etc. Sample masks prepared in this pattern are found to be very convenient for the user with easy breathing without discomfort with feedback from volunteers.

### EXAMPLES

The following examples have given by the way of illustration, which were described the scope of the invention and therefore should not be constructed to limit the present invention.

### Example 1: Testing of CSIR-IICT and Commercial Masks at Membrane Lab

The experimental trials were conducted to estimate the performance of the designed mask. The external agency SITRA has carried out tests to evaluate bacterial filtration efficiency, particulate filtration efficiency, breathability, flammability, and splash resistance as per ASTM test methods. The water and air permeability tests were carried out with the indigenous test setup.

The test reports for all the mentioned physical parameters are enclosed in Annexure A&B. Also, a cost comparison study was conducted on our designed mask with commercially available masks in the market. A detailed description of the tests conducted on developed face masks and their comparison with commercial face masks are provided in Table 1.

TABLE 1
Testing of CSIR-IICT and Commercial Masks at Membrane Lab

| S. | | | Fresh | 5 | 10 | 20 | 30 |
|---|---|---|---|---|---|---|---|
| No | Mask | Parameters | Mask | washes | washes | washes | washes |
| 1. | CSIR-IICT | Breathability | | ✓ | ✓ | ✓ | ✓ |
| | 4-Layered | Appearance | ✓ | ✓ | ✓ | ✓ | ✓ |
| | Face Mask | Fit | ✓ | ✓ | ✓ | ✓ | ✓ |
| | (Cost | Flame Extinguishing | ✓ | ✓ | ✓ | ✓ | ✓ |
| | INR | Test | | | | | |
| | 12.974/—) | Shape & Size | ✓ | ✓ | ✓ | ✓ | ✓ |
| | | Water Repulsion, 10 | 252 | 247 | 235 | 227 | 157 |
| | | ml | | | | | |
| | | (Hold up time in | | | | | |
| | | Seconds) | | | | | |
| 2. | Commercial | Breathability | ✓ | x | x | x | x |
| | Cotton Face | Appearance | ✓ | x | x | x | x |
| | Mask | Fit | ✓ | x | x | x | x |
| | (Cost | Flame Extinguishing | x | x | x | x | x |
| | INR 75/—) | Test | | | | | |
| | | Shape & Size | ✓ | x | x | x | x |
| | | Water Repulsion, 10 | 3 | 2 | 1 | 0 | 0 |
| | | ml | | | | | |
| | | (Hold up time in | | | | | |
| | | Seconds) | | | | | |

### Example 2: Washability Test

The prepared masks underwent multiple washes ranging from 5 to 30. Prepared masks were washed and dried to observe the changes for every 5, 10, 20, 30 washes. The performance of the designed mask was compared with a commercially available cotton mask. The ready 04-layered masks are extensively tested for, durability, breathability, appearance and fitness and results are summarized in Table 2.

TABLE 2
Physical parameters observed during washability test

| | | | | |
|---|---|---|---|---|
| No of | 5 | 10 | 20 | 30 |
| washes | | | | |
| Appearance | No change | No change | No change | Front layer |
| | | | | has shown |
| | | | | wrinkles |
| Wearability | Snug Fit | Snug Fit | Snug Fit | Loose Fit |
| Physical | Seams and | Seams and | Seams and | Seams and |
| Damage | stitches | stitches | stitches | stitches |
| | held up | held up | held up | held up |

### Example 3: Bacterial Filtration Efficiency Test

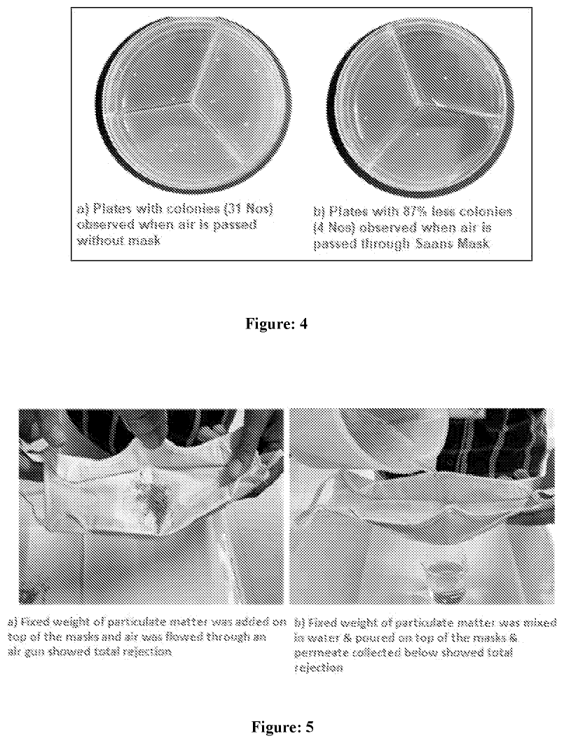

The bacterial filtration efficiency test was conducted at Membrane Separations Laboratory CSIR-IICT to determine the number of bacteria passing through the mask. The mask was sterilized under UV-radiation for 15 min on both sides to eliminate microbial contamination. Simultaneously, medium plates were prepared by pouring 30 mL of nutrient media into each petri dish. After solidification of nutrient media, the sterilized mask was placed on one plate and another plate with nutrient media alone. These plates were exposed to 100 L of air for 4 h and incubated at 37° C. for 24 h. In the end, the colonies were counted to determine the bacterial filtration efficiency using a colony counter and results are summarized in Table 3, FIG. 4 (a and b).

TABLE 3
Bacterial Filtration Efficiency observed for different layers

| | | Bacterial Filtration |
|---|---|---|
| S. No. | Filtration Unit Arrangement | Efficiency (BFE %) |
| 1. | Plain cotton cloth | 57% |
| 2. | Plain Polypropylene Nonwoven | 45.45% |
| 3. | Warp Knit Membrane derived PET layer | 28% |
| 4. | Quadruple Layered Face Mask | 95% |

### Example 4: Particulate Filtration Efficiency

Particulate matter of an average size 0.3 μm was injected through the mask using air and water media. From the experimental results tabulated in table-4 showed that the mask has a PFE of 83.57%.

TABLE 4
Experiments performed for estimation
of particulate filtration efficiency

| | | Particulate |
|---|---|---|
| S. No | Experiment | Filtration Efficiency |
| 1 | Trial I | 83.86 |
| 2 | Trial II | 83.58 |
| 3 | Trial III | 83.57 |

### Example 5: Air and Water Permeability Testing

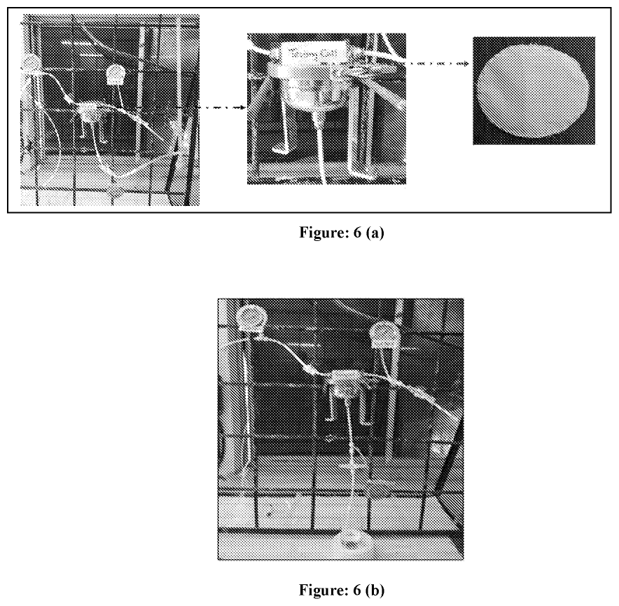

The air and water permeability tests were conducted in stainless steel (SS) testing cell as shown in FIGS. 6a and 6b. The mask was cut into a circular shape with an effective surface area of 0.0072 m². Then it was placed inside the SS cell that is stiffened and secured with flanges from both sides. Three polyurethane (PU) pipelines namely feed, permeate, and reject were connected to the cell. Through the feed line, air or water is passed to the mask. Three pressure gauges and three control valves were fixed to the feed, permeate, and reject lines respectively. Firstly, a controlled supply of air at the pressure of 0.5 bar was passed to the testing cell. The reject line was usually kept closed. At the applied pressure, the permeate air starts flowing downstream slowly after penetrating through the mask. Consequently, when a steady state is reached, the volumetric flow rate of permeation was measured using the soap bubble flow meter. On the other hand, the water testing was conducted by passing water through the feed stream, connecting it to the test cell followed by pressure gauge and control valve. A sufficient amount of pressure (0.5 bar) was applied to the cell to pass water through the mask. The filtered water was collected from the permeate side to know the mask permeability and efficiency. Detailed experimental results are provided in Table 5.

TABLE 5
Air and water permeability test

| | | Applied | Warp knit quadruple |
|---|---|---|---|
| | | pressure | face mask permeability |
| S. No. | Properties | (bar) | (Lit/m² · h) |
| 1. | Air Permeability | 0.5 | 843496 |
| 2. | Water Permeability | 0.5 | 1185 |

The overall comparison of all the properties for warp knit quadruple face mask designed by CSIR-IICT and commercial N95 mask is listed in Table 6.

TABLE 6
Comparison between the IICT and N95 Efficient mask

| | | | Commercial |
|---|---|---|---|
| S. No. | Properties | CSIR-IICT Mask | N95 Mask |
| 1. | Reusability | High (Washable | Low |
| | | texture) | |
| 2. | Hydrophobicity | High (PET & PP | High (PP Layer) |
| | | Layers) | |
| 3. | Air Permeability * | High (843496 | Low (384250 |
| | | Lit/m² · h) | Lit/m² · h) |
| 4. | Water Permeability * | Low (1185 | Moderate (3156 |
| | | Lit/m² · h) | Lit/m² · h) |
| 5. | Tortuosity | High (More no. | Low |
| | | of layers) | |
| 6. | % Filtration | 95.7% rejection | 95% rejection |
| | Efficiency | of bacteria, | |
| | | 83.57% rejection | |
| | | of particulate | |
| | | by 04 layered | |
| | | mask | |
| 7. | Non-Return Valve | No Valve for | Valve is provided |
| | | Better Safety | |
| 8. | Affordability | Rs. 12.974/— | Rs. 100/— |
| | | | to 300/— |

* Tested at 7.25 psi (g) pressure and 28 ± 2° C. temperature
IICT Mask is 2.2 times more breathable than N95 mask.
IICT mask repels water more with only 37% of water permeation as N95 mask.
Ratio of Air to Water Permeability for IICT Mask: 712
Ratio of Air to Water Permeability for N95 mask: 122

The price estimation of the present mask was successfully studied and compared with the commercially available masks in the market which is provided in Table 5. The physical properties such as reusability, hydrophobicity, air and water permeability, tortuosity, affordability were determined for comparison (Table 5). It was observed that the newly developed mask is highly efficient when compared to the commercial masks in terms of cost and performance (Table 7).

TABLE 7
A comparison of the cost of state-of-the-art masks

| | | Khadi | | | | | | |
|---|---|---|---|---|---|---|---|---|
| Company | CSIR-IICT | essentials | Wildcraft | Impulse | Dillinger | Clovia | CP-MED | Aero |
| Cost | 12.974/— | 200/— | 150/— | 100/— | 80/— | 288/— | 500/— | 165/ |
| (in INR) | | | | | | | | |
| Usage & | Continuous | Used in hot | Low heat | High | Extremely | Extremely | Continuous | Several hours |
| Comfort | usage | and cold | build-up | temperature | light | light | usage up to | of |
| | because of | conditions | | resistant | weight | weight | 8 h | uninterrupted |
| | breathability | | | | | | | usage |
| | and | | | | | | | |
| | lightweight | | | | | | | |
| Reusability | Reusable | Reusable | Reusable | Reusable | Washable | Dispose | Disposable | Disinfection |
| | after gentle | | with | and | and | of after | | for Reuse |
| | hand wash | | gentle | washable | reusable | use | | |
| | | | hand | | | | | |
| | | | wash | | | | | |
| No. of | 4 | 5 | 6 | 4 | 3 | 3 | 5 | 5 |
| layers | | | | | | | | |
| Anti- | Hydrophobic | Activated | Melt | Bacterial | — | Non- | melt-blown | Activated |
| microbial | PP layers | carbon | blown | filter | | woven | fabric | Carbon Air |
| Layer | | | layers | | | melted | | Filter |
| | | | | | | blown | | |
| Grade | 95.7% | N95 | W95 | I95 | — | N95 | KN95 (>95% | N95(95% |
| | filtration | (bacterial | (bacterial | (bacterial | | (bacterial | non- | filtration |
| | efficiency* | resistance | resistance | resistance | | resistance | oil-based | efficiency) |
| | | 95%) | 95%) | 95%) | | 95%) | particle) | |

### Example 6: Cost Estimation

In continuation of the design of multilayered masks the cost estimation analysis has been carried out as part of the invention. The materials used for the design of multi-layered masks and its costs for the unit piece were calculated and provided in Table 8. Based on this analysis the materials provided in the table are available in the market and cost-effective.

TABLE 8
Multi-layered Masks- Cost Estimation Per Unit Piece

| Name of Component | Price (in INR) |
|---|---|
| Waste Derived Hydrophobic PET Layer | 6.18 |
| Ultrathin Hydrophobic Polymer Layer | 1.89 |
| Tightly Woven Textile Fabric: 2 Layers | 1.98 |
| Elastic Bands | 0.8 |
| Deionized Water | 0.004 |
| Amenities (Including stitching charges) | 1.5 |
| Beads | 0.62 |
| Total Cost per Mask (Rs.) | 12.974 |

### Example 7: Contact Angle Test Using Goniometer

Individual layers of the designed mask were tested to determine their contact angle using the sessile drop method using a software control system. The measurements were performed by dispensing a water droplet from a Hamilton syringe on the masks layer that is affixed on a glass plate. The sample is held within the focal length of the magnifying camera and backlight focus, intensity of the incident light was adjusted using computer aided software. Proprietary algorithms supplied along with the instrument were used to deduce the contact angles formed by the drop captured at a programmed rate by a frame grabber.

### Example 8: Scanning Electron Microscopic Analysis

All the four layers of the mask were analyzed for determining the surface morphology, micro structure size of the material at varied magnification and provided in Table 9. The analysis was carried out by using a JSM 5410 model scanning electron microscope (SEM) (JEOL Ltd, Tokyo, Japan). The specimens were fragmented in liquid nitrogen before being subjected to the device, and then a thin amount of gold coating was applied as per standard methods.

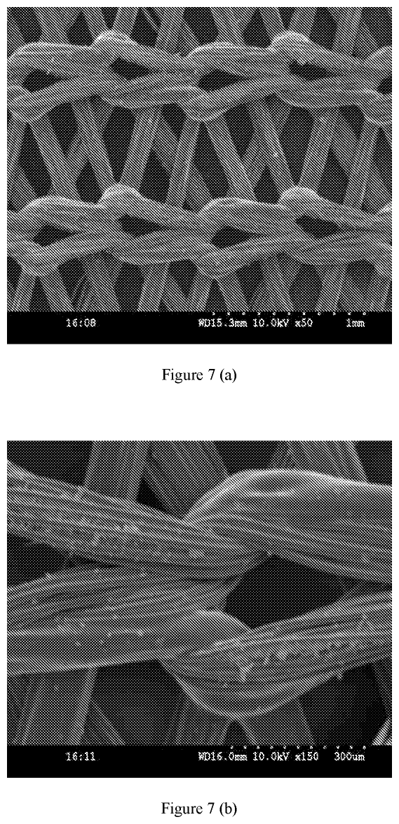

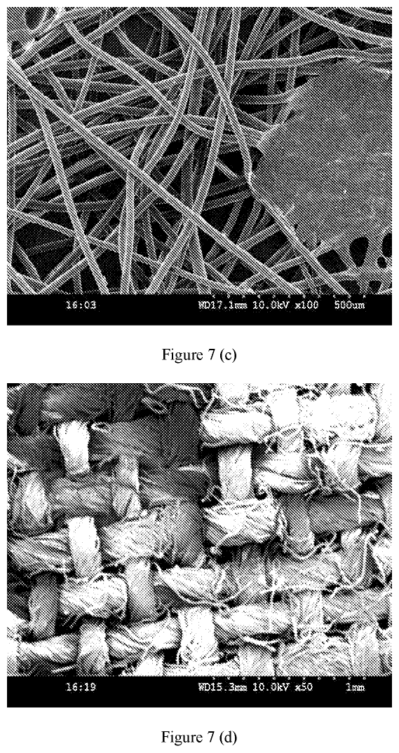

TABLE 9
Mask- microscopic view of internal structure

| | | Scanning Image | | | |
|---|---|---|---|---|---|
| | | specification | | | |
| | Type | Magnifi- | | | |
| Layer No. | of layer | cation (X) | Scale | | Structure/Figure |
| 1^{st} | Cotton | 50 | 1 | mm | Interlacing/ basket- |
| | | | | | type configuration |
| | | | | | of the yarns in a |
| | | | | | woven fabric/FIG. 7d |
| 2^{nd} | PET | 50 | 1 | mm | Warp knit |
| | | | | | configuration/ |
| | | | | | FIG. 7a |
| 2^{nd} | PET | 150 | 300 | μm | Sequential gap between |
| | | | | | the knitted fabric |
| | | | | | with clear looping |
| | | | | | configuration of the |
| | | | | | yarns thus constituting |
| | | | | | the basis of most warp |
| | | | | | knit structures/FIG. 7b |
| 3^{rd} | PP | 100 | 500 | μm | Confirming non-woven |
| | | | | | structure with the |
| | | | | | presence of bypass of |
| | | | | | further processing for |
| | | | | | yarn formation/FIG. 7c |
| 4^{th} | Cotton | 50 | 1 | mm | Interlacing/basket- |
| | | | | | type pattern/FIG. 7d |

### ADVANTAGES OF THE PRESENT INVENTION

The polyethylene terephthalate membrane permeate spacer incorporating face mask #contains waste membrane spacer from used reverse osmosis (RO) as of the layer that provides mechanical strength and washable texture to the entire mask and filters airborne contaminants.
The exclusive 3D pattern of the polyethylene terephthalate membrane permeate spacer incorporating face mask makes the user to breath and speak comfortably by not restricting any facial movements and prevents spectacle fogging. The soft finish of the mask provides comfort to the users.
The polyethylene terephthalate membrane permeate spacer incorporating face mask is washable and reusable up to a duration of 3-4 months, without loss of shape or properties.
The unique feature of the developed polyethylene terephthalate membrane permeate spacer incorporating face mask #s the usage of waste RO membrane spacer which reduces the plastic pollution and follows green technology process as it can be recycled with zero waste discharge.

We claim:

1. A quadra lamina face mask comprising a reused microporous hydrophobic warp knit PET [polyethylene terephthalate] permeate spacer extracted from waste spiral wound RO/UF membrane modules, which offers abatement in plastic pollution through the reuse of PET spacer component of waste spiral membrane modules, wherein the face mask comprises of the following layers from the outside in:
a) Outer layer [1], wherein the outer layer is comprised of a tightly woven cotton textile layer with a 100×100 count specification that acts as a per-filter that prevents the entry of particulate matter of sizes ≥5-10 μm (FIG. 1 a, b) and also improves the appearance of the face mask;
b) Second layer [2], wherein the second layer is consisting of a microporous hydrophobic polyethylene terephthalate (PET) membrane spacer fabric (FIG. 1 a) extracted from used spiral wound reverse osmosis or ultrafiltration membrane modules to repel the respiratory droplets coming in contact with the mask through electrostatic repulsion and high contact angle;
c) Third layer [3], wherein the third layer comprises of a hydrophobic polypropylene (PP) nonwoven layer is positioned subsequent to the PET layer from the front-end side; and
d) Inner layer [4], wherein the inner layer is in contact with the face and is made of a tightly woven cotton textile layer to provide the wearer comfort and enable prolonged usage, and said four layers (FIG. 1 a, b) are stitched tightly to offer tight porosity of ≤0.3 μm and water repulsion.

2. The face mask as claimed in claim 1, wherein the woven cotton textile outer layer [1] prevents inhalation of airborne contaminants, especially large-sized particulates and gives a soft finish and proper structure to the mask providing comfort to the users.

3. The face mask as claimed in claim 1, wherein microporous hydrophobic PET second layer [2] as the permeate spacer extracted from used spiral wound reverse osmosis or ultrafiltration membrane modules prepared by warp knitting for preventing inhalation of airborne contaminants such as large particulates, pollen, dust, bacteria, and other pathogens and help in reducing solid waste generation.

4. The face mask as claimed in claim 1, wherein porous polypropylene non-woven third layer [3] adjacent to the PET layer which acts as a filter to restrict the pollutants or the contaminants which are not captured by other layers.

5. The face mask as claimed in claim 1, wherein hydrophobic polypropylene (PP) nonwoven layer [3] is positioned next to the PET layer [2] which restricts further entry of the pollutants that pass through one and two layers.

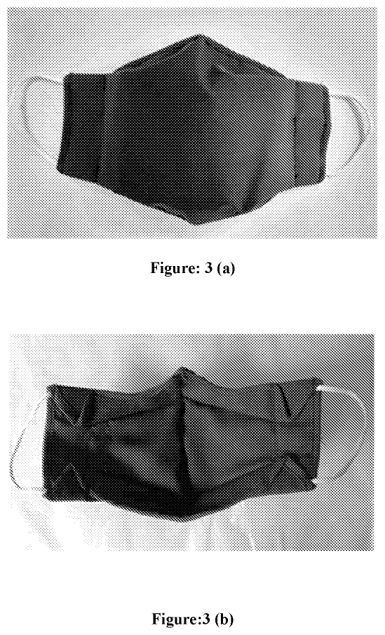

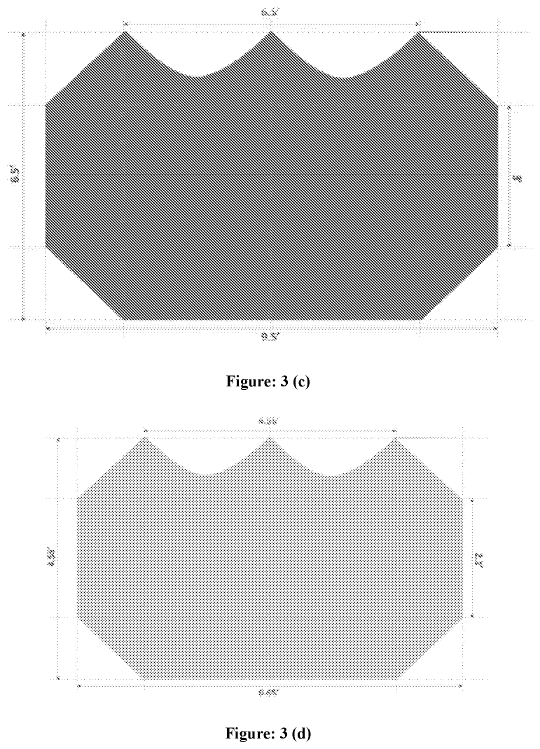

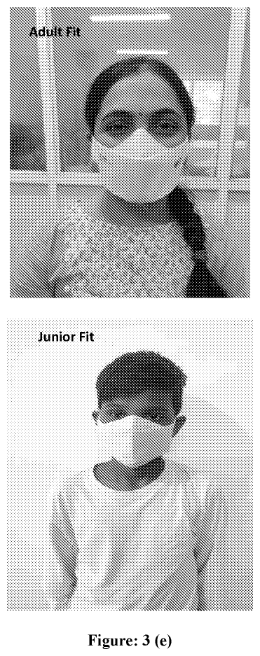

6. The face mask as claimed in claim 1, wherein the dimensions of the individual layers of the mask are measured as 9.5″×6.5″ (FIG. 3c), and 6.65″×4.55″ (FIG. 3d), are trimmed accordingly for universal size and junior size, respectively.

7. The face mask as claimed in claim 1, wherein the mask is designed with an exclusive 3D pattern (FIG. 3) that has effective face coverage not restricting any facial movements, along with no difficulty in speaking and breathing and can be reused for 3 months or up to 30 washes.

8. The face mask as claimed in claim 1, wherein the bacterial filtration efficiency of designed face masks is 95.7% against Staphylococcus aureus ATCC 6538 when tested according to ASTM F 2101 test method whereas the overall filtration efficiency towards the total fungi, gram-positive and gram-negative bacteria present in atmosphere was found to be 90% using open plate method and the particulate filtration efficiency of the developed mask, 0.3 μm particles is 83.57% as per ASTM F2299 test method.

9. The face mask as claimed in claim 1, wherein breathability for the developed mask is 211.01 Pa/cm² when tested the Differential pressure-EN 14683 test method and flammability of the developed mask is 38.8 seconds when it is inclined at 45° in an auto flame chamber and when tested with the 16CFR Part-1610 test method, the average burn time of Class I category being ≥3.5 sec.

10. The face mask as claimed in claim 1, wherein multilayered mask exhibits a high air permeability 2.2 times greater than the expensive standard N-95 masks available across the counter with only 37% of the water permeability obtained through N-95 masks, at a pressure differential of 0.5 bar ensuring greater breathability with better protection against respiratory droplets that could carry pathogens.

11. A process for preparation of quadra lamina face mask, comprising:
a) preparing an outer layer [1] using a tightly woven cotton textile layer with a 100×100 count specification that acts as a per-filter that prevents the entry of particulate matter of sizes ≥5-10 μm and also improves appearance of the face mask;
b) preparing a second layer [2] using a microporous hydrophobic polyethylene terephthalate (PET) membrane spacer fabric, extracted from used spiral wound reverse osmosis or ultrafiltration membrane modules, to repel respiratory droplets coming in contact with the face mask through electrostatic repulsion and high contact angle;
c) preparing a third layer [3] using a hydrophobic polypropylene (PP) nonwoven layer, positioned subsequent to the PET layer from the front-end side;
d) preparing an inner layer [4] having direct contact with the face using a tightly woven cotton textile layer to provide the wearer comfort and enable prolonged usage;
e) stitching tightly all the layers with each-other to offer tight porosity of ≤0.3 μm and water repulsion.
